(19) United States
(12) Patent Application Publication
(10) Pub. No.: US 2018/0005121 A1
(43) Pub. Date: Jan. 4, 2018

(54) PROVIDE ENHANCED RELATIONSHIP GRAPH SIGNALS

(71) Applicant: MICROSOFT TECHNOLOGY LICENSING, LLC, Redmond, WA (US)

(72) Inventors: Rezaul Hoque, Oslo (NO); Vando Pereira, Oslo (NO); Manolis Platakis, Oslo (NO); Olivia Ifrim, Oslo (NO)

(73) Assignee: MICROSOFT TECHNOLOGY LICENSING, LLC, Redmond, WA (US)

(21) Appl. No.: 15/196,083

(22) Filed: Jun. 29, 2016

(51) Int. Cl. G06N 5/04; G06F 17/30; G06N 99/00

(52) U.S. Cl. CPC G06N 5/04; G06N 99/005; G06F 17/30327; G06F 17/3053

(57) ABSTRACT

Enhanced relationship graph signals are provided. A productivity service initiates operations to provide enhanced relationship graph signals by retrieving relationship attribute(s) between two users of a productivity service. Interactivity attribute(s) between the two users of the product service are also retrieved. An enhanced signal is generated based on the relationship and interactivity attributes. The enhanced signal is stored within a relationship graph.

### BACKGROUND

Information collection, management, and analysis have changed work processes associated communication management. Automation and improvements in work processes have expanded scope of capabilities offered by businesses. With the development of faster and smaller electronics execution of mass processes at cloud based systems have become feasible. Indeed, analysis work at data centers, data warehouses, data workstations have become common business features in modern work environments. Such systems execute a wide variety of applications ranging from enterprise resource management applications to complicated product tools. Many such applications process communications to attempt to improve interactions with the communications. Email as a communication platform offers an intersect between instant communication and reliable access to documentation associated with the communication.

Vast number of communications, data volume associated with the communication, and communication modalities complicate reliable communication between individuals, groups, and organization. Indeed, fast changing dynamics of communication modalities complicate access to information stored within a communication. Complications with multiple communication sources, communication types, and complexity of information provided by volume of communications and communication modalities may lead to mismanagement of information transmitted through communications and access by an interested party.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing enhanced relationship graph signals. A productivity service, according to embodiments, may initiate operations to provide enhanced relationship graph signals by retrieving relationship attribute(s) between two users of a productivity service. Interactivity attribute(s) between the two users of the product service may also be retrieved. An enhanced signal may be generated based on the relationship and interactivity attributes. The enhanced signal may be stored within a relationship graph.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A through 1B are conceptual diagrams illustrating examples of providing an enhanced relationship graph signal, according to embodiments;

FIG. 2 is a display diagram illustrating example components of a productivity service that provides an enhanced relationship graph signal, according to embodiments;

FIG. 3 is a display diagram illustrating components of a scheme to provide an enhanced relationship graph signal, according to embodiments;

FIG. 4 is a display diagram illustrating an example of an interface that provides enhanced signal and signal value associated with a communication based on a relationship graph, according to embodiments;

FIG. 5 is a simplified networked environment, where a system according to embodiments may be implemented;

FIG. 6 is a block diagram of an example computing device, which may be used to provide an enhanced relationship graph signal, according to embodiments; and

FIG. 7 is a logic flow diagram illustrating a process for providing an enhanced relationship graph signal, according to embodiments.

### DETAILED DESCRIPTION

As briefly described above, a productivity service may provide an enhanced relationship graph signal. In an example scenario, the productivity service may retrieve relationship attribute(s) and interactivity attribute(s) between two users. The two users may be identified as property(s) of a communication upon an analysis of the communication. The analysis may also identify an address of the recipient, an address of a sender, an address of a co-recipient, a date and time of a transmission, a subject, and/or a topic extracted from a content of the communication, among others as properties of the communication.

Next, an enhanced signal may be generated based on the relationship and interactivity attributes. The enhanced signal may be stored within a relationship graph. The relationship graph may represent a collection of content and activity, and the relationships between them that happen across an entire environment such as a productivity suite. From email, social conversations, and meetings, to documents in a collaboration service and collaborative data stores, the relationship graph may map the relationships rumors people and information, and provide information that can be used as the foundation for many experiences that are more relevant and personalized to each individual. The relationship graph may use machine learning techniques to connect people to the relevant content, conversations and people around them.

In the following; detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide enhanced relationship graph signals. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing, device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

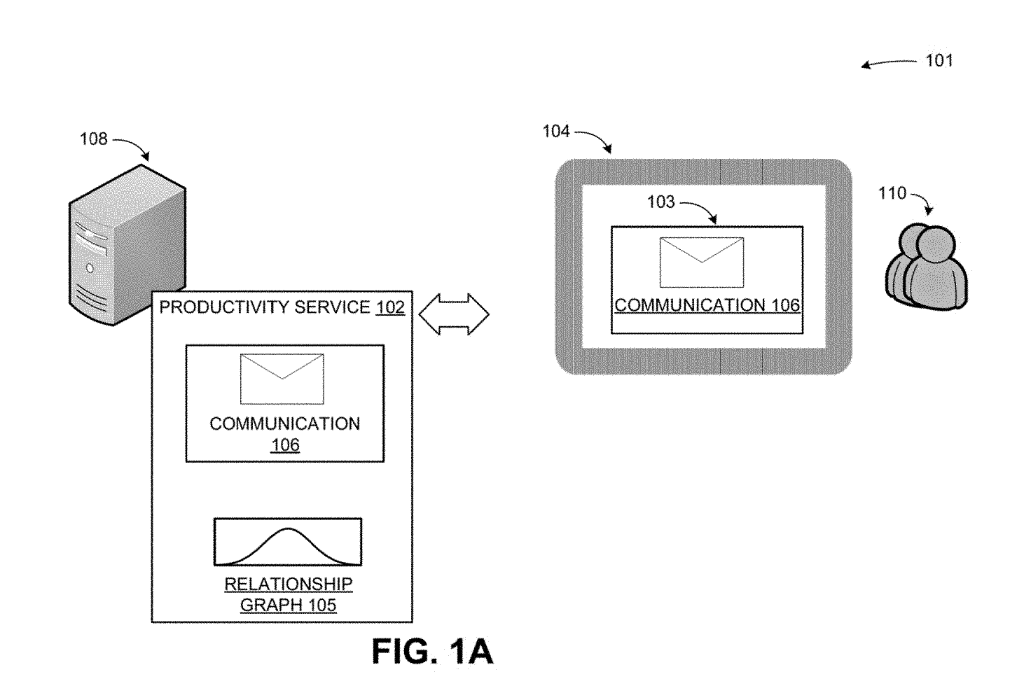

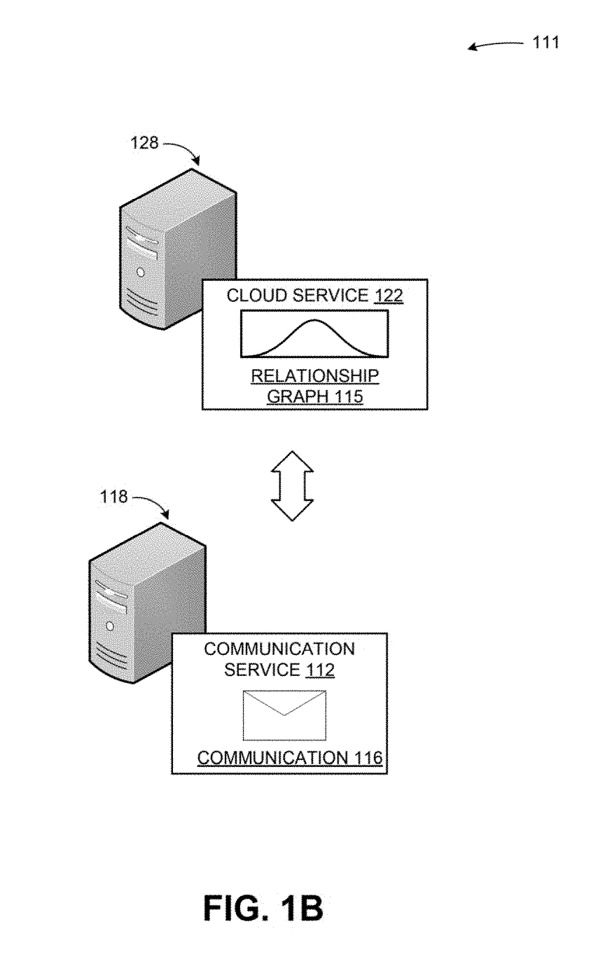

FIG. 1A through 1B are conceptual diagrams illustrating examples of enhanced relationship graph signals, according to embodiments.

In a diagram 101 of FIG. 1A, a productivity server 108 may execute a productivity service 102. The productivity server 108 may include a physical server providing service(s) and/or application(s) to client devices. A service may include an application performing operations in relation to a client application and/or a subscriber, among others. The productivity server 108 may include and/or is part of a workstation, a data warehouse, and/or a data center, among others.

The productivity server 108 may execute the productivity service 102. The productivity service 102 may initiate operations to provide enhanced relationship graph signals by retrieving relationship attribute(s) and interactivity attribute(s) between two users. The two users may be identified as property(s) of a communication upon an analysis of the communication. Signals associated with the two users may be retrieved from a relationship graph to generate the relationship and interactivity attributes. Furthermore, additional users (who send and/or receive the communication 106) may be used to generate the relationship and interactivity attributes. The analysis may also identify an address of the recipient, an address of a sender, an address of a co-recipient a date and time of a transmission, a subject, and/or a topic extracted from a content of the communication, among others as properties of the communication.

The relationship and/or interactivity attributes may be retrieved from an analysis of signals associated with the communication 106. A signal may include a periodic or continuous measurement of a property of the communication 106 associated with two entities such as two users. The relationship graph 105 may store the signals that describe a frequency, a duration, a date and time, a summary, and/or a result (among others) of interactions and/or relationships between users 110 (and other user(s)). The signals may be retrieved from the relationship graph 105. The relationship graph 105 may be collected, processed, generated, and/or updated by a provider such as a cloud service from a variety of sources that provide information associated with the recipient and other entities. Alternatively, the productivity service 102 may manage the relationship graph 105.

The productivity server 108 may communicate with the client device 104 through a network. The network may provide wired or wireless communications between nodes such as the client device 104, or the productivity server 108, among others. Previous example(s) to provide enhanced relationship graph are not provided in a limiting sense. For example, the communication 106 may include an email, a message, and/or a conference call, among others. Furthermore, the productivity service 102 may alternatively manage the communication 106 at a desktop application, a workstation application, and/or a server application, among others. A client application 103 may display the communication 106. The client application 103 may be a stand-alone application that interacts with the productivity service 102. The client application 103 may also include a client interface of the productivity service 102.

The users 110 may interact with the client application 103 with a keyboard based input, a mouse based input, a voice based input, a pen based input, and a gesture based input, among others. The gesture based input may include one or more touch based actions such as a touch action, a swipe action, and a combination of each, among others.

In a diagram 111 of FIG. 1B, a system that includes a productivity service 112 (executing on a productivity server 118) and a cloud service 122 (executing on cloud server(s) 128) is described. The productivity service 112 may interact with the cloud service 122 to retrieve relationship and interactivity attributes associated with two users by an analysis of the communication and processing signals associated with the communication and the users. The signals may be retrieved from the relationship graph 115.

The cloud service 122 may include a third party service provider. Furthermore, the cloud service 122 may execute operations to provide the relationship graph 115. For example, the cloud service 122 may interact with content providers to download and update information associated with an entity (a node such as a user) and a relationship of the entity with other entity (such as another user).

In an example scenario, the cloud service 122 may search a social networking provider to gather information associated with users. The productivity service 112 may query the cloud service 122 with information extracted from the communication and/or information associated with users identified in the communication such as a recipient, a sender, and/or co-recipient, among others. The information may include an identification, a property, an interest, and/or a characteristic, among others associated with the users or identified in the communication 116. The information may be processed to generate a signal associated with the two users which may be stored in the relationship graph 115.

While the example systems in FIG. 1A through 1B have been described with specific components including the productivity server 108, the productivity service 102, embodiments are not limited to these components or system configurations and can be implemented with other system configuration employing fewer or additional components.

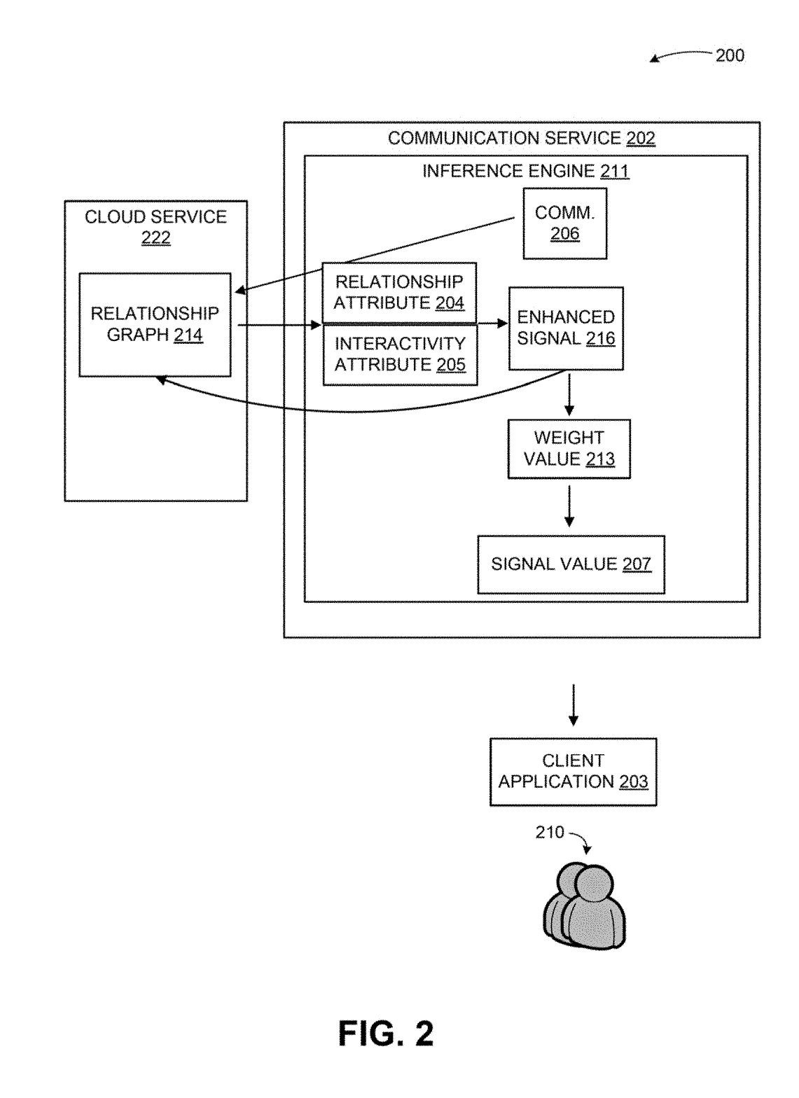

FIG. 2 is a display diagram illustrating example components of a productivity service that provides enhanced relationship graph signals, according to embodiments.

In a diagram 200, an inference engine 211 of a productivity service 202 may interact with a cloud service 222 to generate an enhanced signal based on relationship and interactivity attributes associated with users 210 and the communication 206. The inference engine 211 may analyze the communication 206 to identify properties such as two users (a recipient and a sender), an address of a recipient, an address of a sender, an address of a co-recipient, a date and time of a transmission, a subject, and/or a topic extracted from a content of the communication 206. The properties may be used to query relationship graph 214 to retrieve signals associated with the properties of the communication 206. The retrieved signals may include measurements associated with the properties of the communication 206 such as a frequency of interaction between the users 210, a recentness of interaction between the users 210, a level of the interaction (such as in person, voice communication, text based communication) between the users 210, among others related to the properties extracted from the communication 206.

The signals retrieved from the cloud service 222 may be analyzed to retrieve relationship attribute(s) 204 and interactivity attribute(s) 205 from the signals. In an example scenario, the inference engine 211 may retrieve asocial distance signal from the relationship graph 214 based on property(s) of the communication 206. The social distance signal may describe the relationship attribute 204 between the users 210 by encompassing a number of signals that provide measurements associated with a relationship between the users 210.

Furthermore, an interaction signal may also be retrieved from the relationship graph 214 based on property(s) of the communication 206. The interaction signal may describe the interactivity attribute 205 between the users 210 by encompassing a number of signals that provide measurements associated with interactions between the user 210.

The relationship attribute 204 and the interactivity attribute 205 may be used to generate an enhanced signal 216. The relationship graph 214 stores values for each signal to quantify a described measurement by the signal. As such, the relationship attribute 204 and the interactivity attribute 205 are combined to form the enhanced signal 216 which also is quantified with a value combined from the values of the signals that compose the enhanced signal 216. A precursor value (that may be calculated front retrieved signals) may be processed with a weight value 213 to produce the signal value 207 associated with the enhanced signal 216. The weight value 213 may be an adjustment made by a stakeholder such as the users 210 and/or a machine learning scheme to increase or decrease a value of a signal. The machine learning scheme may monitor relationship(s) and interaction(s) between the users 210, the communication 206, and property(s) of the communication 206 located in other communication(s) to adjust the weight value to reflect an interest in the communication 206. The weight value 213 may be a tool for the stakeholder to adjust a signal value to an actual value associated with the measured interactions and/or relationships between the users 210.

The enhanced signal 216 may be stored in the relationship graph 214. The relationship graph 214 may make the enhanced signal 216 available for a future search that may attempt to quantify a relationship and/or an interaction between the users 210. The enhanced signal may more accurately reflect a quantity associated with a relationship and/or interactivity between the users 210 because the enhanced signal 216 encompasses multiple signals associated with one or more property(s)extracted from a communication. The enhanced signal 216 may be saved to the relationship graph 214.

The enhanced signal 216 and the signal value 207 may be provided to a client application 203. The client application 203 may use the enhanced signal 216 and the signal value 207 to rank the communication 206 against other communications. The ranked communications may be provided to the users 210. The communication service 202 may instruct the client application 203 for each operation associated with presenting the enhanced signal 216 and/or the signal value 207 to the users 210 (and/or other users).

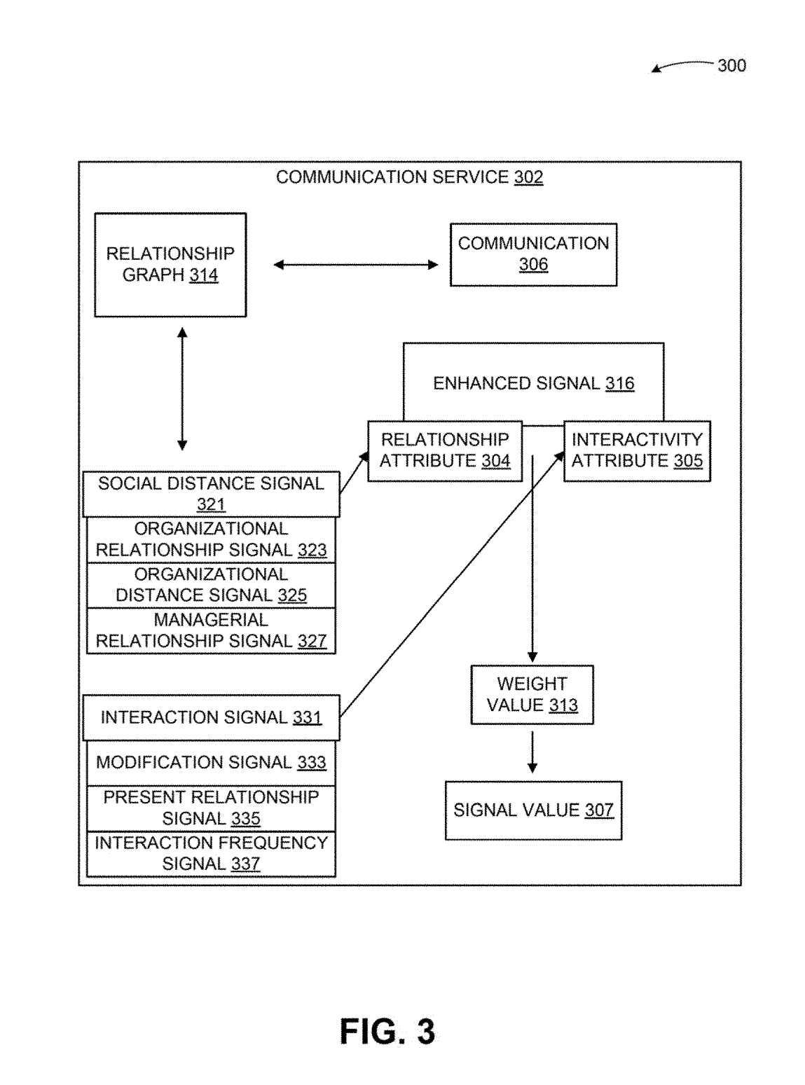

FIG. 3 is a display diagram illustrating components of a scheme to provide enhanced relationship graph signals, according to embodiments.

In a diagram 300, a productivity service 302 may query a relationship graph 314 with property(s) of a communication 306 to retrieve signals associated with the property(s). The property(s) may include two users who are communicating through the communication 306. The property(s) may further include a subject, a content, and/or a time of transmission, among other property(s) of the communication 306.

In an example, signals may be retrieved from the relationship graph 314 and combined to form a social distance signal 321. The social distance signal 321 may describe a social distance between the two users. An example of the two users may include a recipient and a sender of the communication 306.

The social distance signal 321 may be formed from an aggregate of multiple signals located in a relationship graph 314. The relationship graph 314 may be queried and searched with two users for an organizational relationship signal 323. The organizational relationship signal may describe a relationship between the two users. The relationship may include an associate relationship (co-worker, and/or collaborator, among others), a supervisory relationship (the recipient and/or the sender has a supervisory role over the other), and/or a subordinate relationship (the recipient and/or the sender is a subordinate of the other), among others.

The relationship graph 314 may also be queried and searched for an organizational distance signal 325 between the two users. The organizational distance signal 325 may describe a number of people between the two users who are part of an organization. Furthermore, the relationship graph 314 may be queried and searched for a managerial relationship signal 327 between the two users. The managerial relationship signal 327 may describe a managerial relationship between the two users (such as the recipient and/or the sender is a manager of the other).

The organizational relationship signal 323, the organizational distance signal 325 and/or the managerial relationship signal 327 may be received from the relationship graph 314 and combined to form the social distance signal 321. The relationship graph 314 may also be queried for signal values associated with the organizational relationship signal 323, the organizational distance signal 325, and the managerial relationship signal 327. The received signal values may be normalized to a value within a value range. The value range may include 0-1, 0-10, 0-100, 1-10, 1-100, among others. The normalized signal values may be combined to form a signal value for the social distance signal 321. The relationship attribute 304 may be retrieved from the social distance signal 321.

The signal value for the social distance signal 321 may also be used for the relationship attribute 304. A low value may correlate to a short distance between the users. A high value may correlate to a long distance between the users. Alternatively, a correlation between signal value of the social distance signal 321 and a distance between the users may be reversed to produce signal value similarly scored to signal value associated with an interaction signal 331.

In another example of the signals may be retrieved from the relationship graph 314 and combined to form an interaction signal 331. The interaction signal 331 may define interaction(s) between two users (such as a recipient and a sender) of the communication 306.

The interaction signal 331 may be formed from an aggregate of multiple signals located in the relationship graph 314. The relationship graph 314 may be queried with the two users (of the communication 306) to retrieve the signals associated with the two users. Other property(s) of the communication 306 may also be used in addition to the two users to search the relationship graph 314 for signals. The relationship graph 314 may return a modification signal 333 in response to the search. The modification signal 333 may describe a collaboration between the two users. The relationship graph 314 may also be queried and searched for a present relationship signal 335. The present relationship signal 335 may describe an ongoing relationship between the two users. Furthermore, the relationship graph 314 may be queried and searched for an interaction frequency signal 337. The interaction frequency signal 337 may describe a frequency of interaction(s) between the two users.

The modification signal 333, the present relationship signal 335 and/or the interaction frequency signal 337 may be received from the relationship graph 314 and combined to form the interaction signal 331. The relationship graph 314 may also be queried for signal values associated with the interaction signal 333, the present relationship signal 335, and the interaction frequency signal 337. The received signal values may be normalized to a value within a value range. The value range may include 0-1, 0-10, 0-100, 1-10, 1-100, among others. The normalized signal values may be combined to form a signal value for the interaction signal 331. The interactivity attribute 305 may be retrieved from the interaction signal 331.

The signal value for the interactivity signal 331 may also be used for the interactivity attribute 305. A low value may correlate to a small number of interaction(s) between the users. A high value may correlate to a large number of the interaction(s) between the users. Alternatively, a correlation between signal value of the interactivity signal 331 and a number of interactions between the users may be reversed to produce signal value similarly scored to signal value associated with an social distance signal 321.

The signal value for the social distance signal 321 used for the relationship attribute 304 and the signal value for the interactivity signal 331 used for the interactivity attribute 305 may be combined to form a precursor signal value for the enhanced signal 316.

A weight value 313 may be applied to the precursor signal value to reflect an interest of a stakeholder such as one of the two users or both of the two users in the communication 306. A signal value 307 for the enhanced signal 316 may be computed by applying the weight value 313 to the precursor signal value. Applying the weight value 313 to the precursor value may improve the relevance of the communication 306 by increasing the signal value 307 for the enhanced signal 316. Alternatively, applying the weight value 313 to the precursor signal may decline the relevance of the communication 306 by decreasing the signal value 307 for the enhanced signal 316.

The example of an application of the weight value 313 to a precursor signal value of the enhanced signal 316 to compute the signal value 307 was not provided in a limiting sense. Indeed, a stakeholder may be provided with a finer granularity in affecting the outcome of the signal value 307 by providing other weight values applied to other signals that may be adjusted by the stakeholder. The other weight values may be applied to the relationship attribute 304, the social distance signal 321, the organizational relationship signal 323, the organizational distance signal 325, and/or the managerial relationship signal 327. The other weight values may also be applied to the interactivity attribute 305, the interaction signal 331, the modification signal 333, the present relationship signal 335, and/or the interaction frequency signal 337.

Examples of the relationship attribute 304 were not provide in a limiting sense. Other signals (retrieved front the relationship graph 314) may be used to retrieve the relationship attribute 304 and/or the interactivity attribute 305. For example, a trending signal associated with a content of the communication 306 in relation to the two users may be processed to generate the interactivity attribute 305. An importance signal obtained from the relationship graph 314 may also be processed to generate the relationship attribute 304.

Furthermore, other signals may also include signals that indicate one or more of people who communicate with the user often, people the user is close to, a context of the communication trending around the user's colleagues, an importance of the communication, a relevance of the user based on an organizational distance to a sender of the communication, people who are in the communication and are relevant to the user, an explicit reference to the user in a body of the communication, the email is directed only to the user, how influential the sender of the communication is, a relevance of a topic of the communication to the user, and/or a proximity or a relationship between the user and the sender through a management chain, among others. The explicit reference to the user in the body of the communication may include a tag reference to the user and/or a name of the user being included in the body of the communication 306.

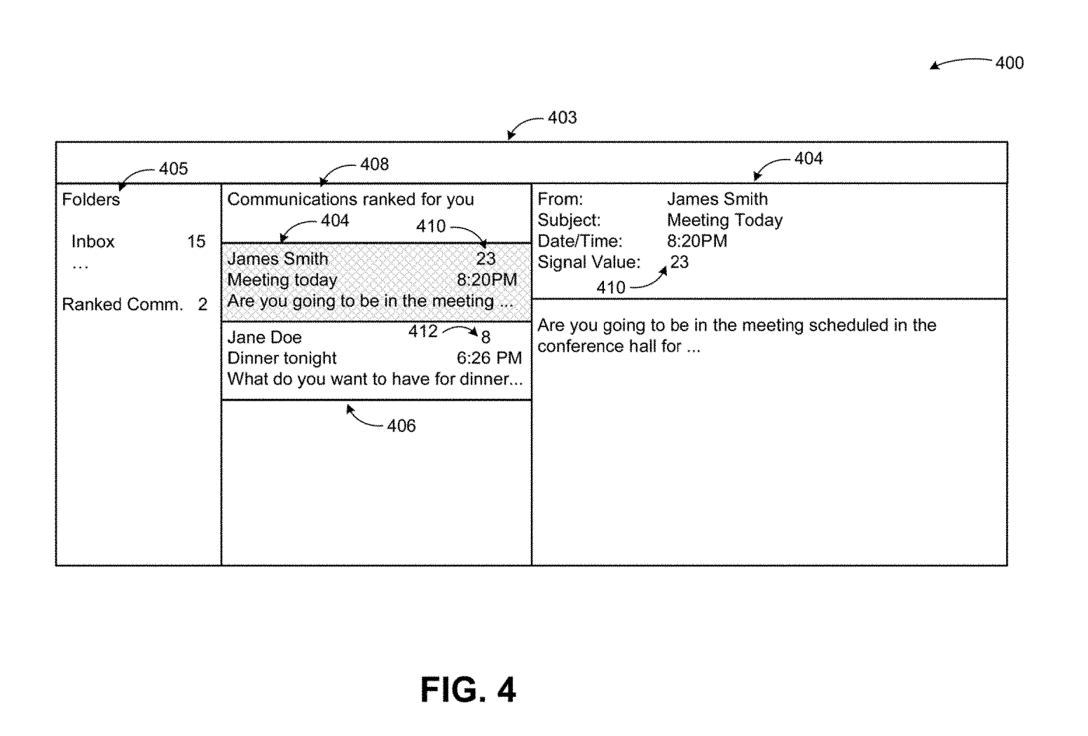

FIG. 4 is a display diagram illustrating an example of an interface that provides an enhanced signal and a signal value associated with a communication based on a relationship graph, according to embodiments.

In a diagram 400, a productivity service may provide an interface to be rendered by a client application 403 or provide data to be displayed by the interface of the client application 403 such as a communication application. The productivity service may provide a communication 404 and a communication 406 that are ordered based on signal values (410 and 412, respectively). The signal values (410 and 412) are generated based on enhanced signal(s) obtained by processing signals retrieved from a relationship graph and combined into a relationship attribute or an interactivity attribute. The client application 403 may also provide navigation elements 405 as controls to access a grouping of the communication(s).

The client application 403 may display the communications (404 and 406) in a section 408 reserved for communications that are ranked based on enhanced signals. A rank of a communication may imply a relevance of the communication to one of the two users viewing the client application 403 (such as a recipient). A higher ranked communication may correlate to a higher relevancy. A lower ranked communication may correlate to a lower relevancy.

The communications (404 and 406) are ordered based on the signal values (410 and 412) computed for enhanced signals. The signal values (410, 412) may simulate an interest of the two users (or one of the two users such as a recipient and/or a sender) in the communications (404 and 406) When selected, the communication 404 may be provided with details such as the signal value 410. The signal value 410 may be provided to affirm an accuracy of the assigned value that is intended to reflect a relevance of the communication 404 to both of the two users or one of the two users. Furthermore, the signal value 410 is provided to prompt the viewing user (from the two users) to adjust the weight value applied to the signal value 410 to reflect the relevance of the communication 404 (to the viewing user).

As discussed above, the productivity service may be employed to perform operations to automate providing enhanced relationship graph signals. An increased user efficiency with the client application may occur as a result of analyzing a communication through the productivity service 102 to generate an enhanced signal from a relationship attribute and an interactivity attribute extracted from signals retrieved from a relationship graph. Additionally, processing the communication, the retrieved signals, the relationship and interactivity attributes, and a weight value, by the productivity service 102, may reduce processor load, increase processing speed, conserve memory, and reduce network bandwidth usage.

Embodiments, as described herein, address a need to efficiently triage and prioritize a communication. The actions/operations described herein are not a mere use of a computer, but address results that are a direct consequence of software used as a service offered to large numbers of users and applications.

The example scenarios and schemas in FIG. 1A through 4 are shown with specific components, data types, and configurations. Embodiments are not limited to systems according to these example configurations. Providing enhanced relationship graph signals may be implemented in configurations employing fewer or additional components in applications and user interfaces. Furthermore, the example schema and components shown in FIG. 1A through 4 and their subcomponents may be implemented in a similar manner with other values using the principles described herein.

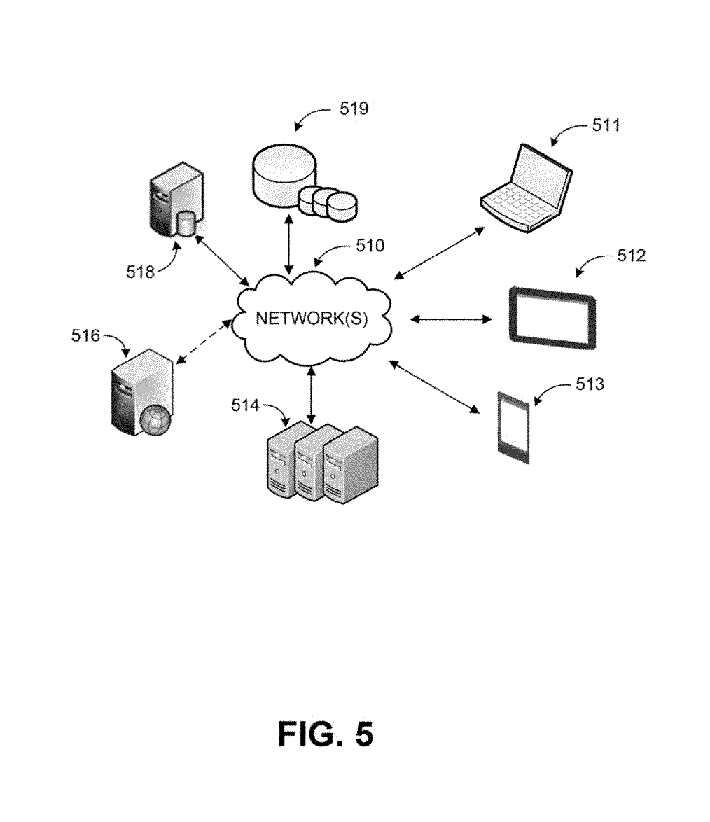

FIG. 5 is an example networked environment, where embodiments may be implemented. A productivity service configured to provide enhanced relationship graph signals may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A productivity service may retrieve relationship attribute(s) between two users of a productivity service. Interactivity attribute(s) between the two users of the product service may also be retrieved. An enhanced signal may be generated based on the relationship and interactivity attributes. The enhanced signal may be stored within a relationship graph. The productivity service may store data associated with the communication in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide enhanced relationship graph signals. Furthermore, the networked environments discussed in FIG. 5 are for illustration purposes only. Embodiments are not limited to the example applications, modules, or processes.

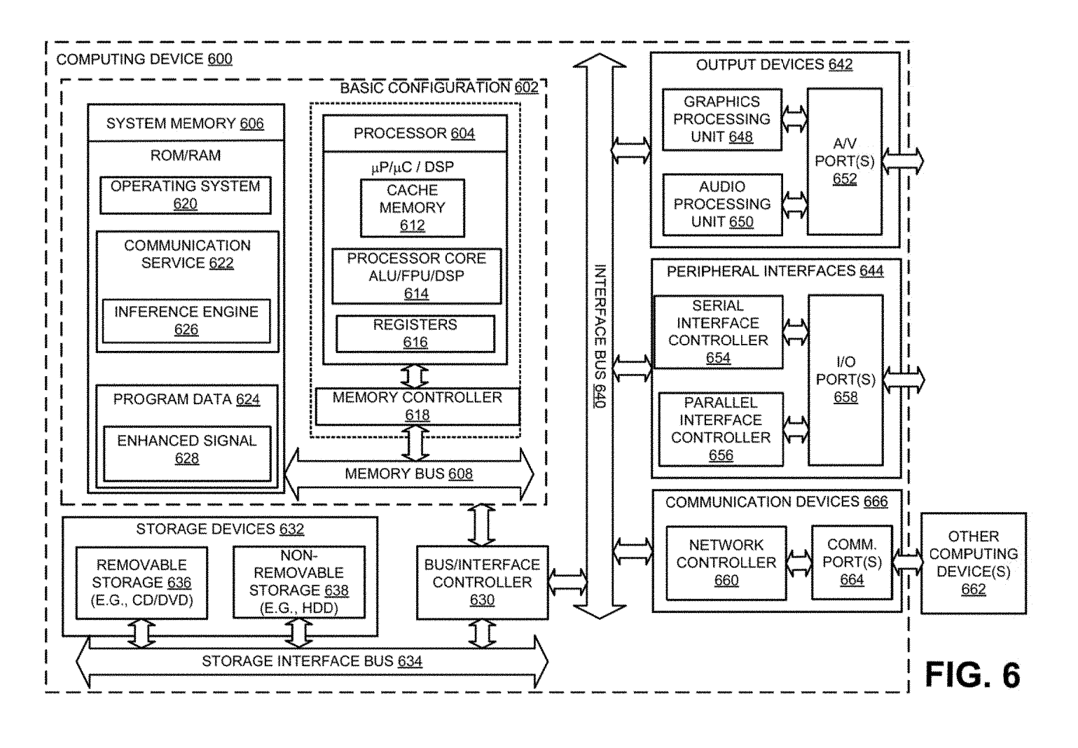

FIG. 6 is a block diagram of an example computing device, which may be used to provide enhanced relationship graph signals, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include components such as an inference engine. The inference engine 626 may execute the processes associated with the productivity service 622. The inference engine 626 may retrieve relationship attribute(s) between two users of a productivity service. Interactivity attribute(s) between the two users of the product service may also be retrieved. An enhanced signal may be generated based on the relationship and interactivity attributes. The enhanced signal may be stored within a relationship graph.

Input to and output out of the productivity service 622 may be transmitted through a communication device associated with the computing device 600. An example of the communication device may include a networking device that may be communicatively coupled to the computing device 600. The networking device may provide wired and/or wireless communication. The program data 624 may also include, among other data, enhanced signal 628, or the like, as described herein. The enhanced signal 628 may include a signal value associated with the communication that may be adjusted with a weight value to reflect a relevance of the communication, among others.

The computing device 600 may leave additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide enhanced relationship graph signals. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

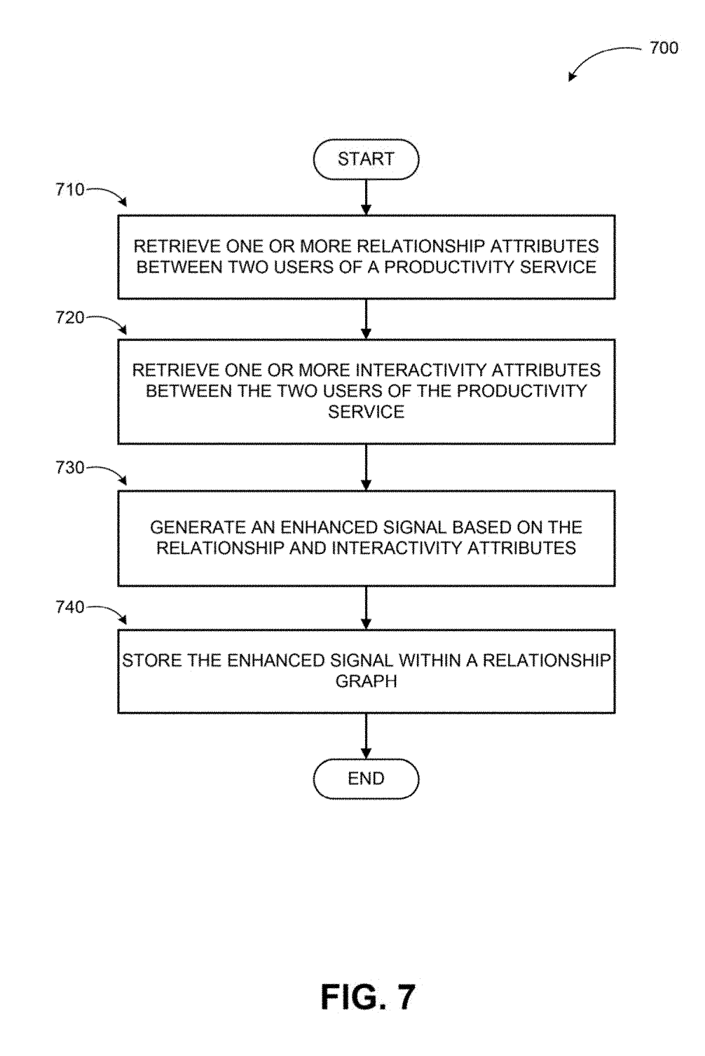

FIG. 7 is a logic flow diagram illustrating a process for providing enhanced relationship graph signals, according to embodiments. Process 700 may be implemented on a computing device, such as the computing device 600 or another system.

Process 700 begins with operation 710, where the productivity service may retrieve relationship attribute(s) between two users of a productivity service. The relationship attribute may be retrieved from signals describing a relationship between the two users, retrieved from a relationship graph. Interactivity attribute(s) between the two users of the product service may be retrieved at operation 720. The interactivity attribute may be retrieved from signals describing an interactivity between the two users, retrieved from the relationship graph.

An enhanced signal may be generated based on the relationship and interactivity attributes at operation 730. Aggregated signal values associated with the relationship and interactivity attributes may be combined to form a precursor signal value for the enhanced signal. At operation 740, the enhanced signal may be stored within a relationship graph.

The operations included in process 700 are for illustration purposes. Providing enhanced relationship graph signals may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a method executed on a computing device to provide enhanced relationship graph signals is described. The method includes retrieving one or more relationship attributes between two users of a productivity service, retrieving one or more interactivity attributes between the two users of the productivity service, generating an enhanced signal based on the relationship and interactivity attributes, and storing the enhanced signal within a relationship graph.

In other examples, retrieving the one or more relationship attributes and the one or more interactivity attributes comprises analyzing in each communication one or more of: an address of a recipient, an address of a sender, an address of a co-recipient, a date and time of a transmission, a subject, and a topic extracted from a content of the communication. Retrieving the one or more relationship attributes further includes receiving one or more of an organizational relationship signal and a social distance signal from the relationship graph and analyzing the organizational relationship signal and the social distance signal to retrieve the one or more relationship attributes. The organizational relationship signal describes a relationship between the two users that includes an associate relationship, a supervisory relationship, and a subordinate relationship.

In further examples, retrieving the one or more relationship attributes further includes receiving one or more of an organizational distance signal and a managerial relationship signal from the relationship graph, where the organizational distance signal describes a number of people between the two users within an organization and analyzing the organizational distance signal and the managerial relationship signal to retrieve the one or more relationship attributes.

In other examples, retrieving the one or more relationship attributes and the one or more interactivity attributes further includes querying the relationship graph for one or more signal values associated with one or more stored signals, where the one or more signal values are normalized to values within a value range. A low value within the value range for a distance signal correlates to fewer people between the two users and a high value within the value range for the distance signal correlates to more people between the two users. A low value within the value range for an interactivity signal correlates to fewer interactions between the two users and a high value within the value range for the interactivity signal correlates to more frequent interactions between the two users. The method further includes applying a weight value to each signal value. The weight value is adjustable by one or more of: one of the two users, a stakeholder, and a machine learning scheme that is configured to process the signals.

In further examples, retrieving the one or more interactivity attributes further includes querying the relationship graph for a modification signal, where the modification signal describes a collaboration between the two users, querying the relationship graph for a present relationship signal, where the present relationship signal describes an ongoing relationship between the two users, querying the relationship graph for an interaction frequency signal, where the interaction frequency signal describes a frequency of the one or more interactions between the two users, and analyzing the one or more of the modification signal, the present relationship signal, and the interaction frequency signal to retrieve the one or more interactivity attributes.

In some examples, a productivity server to provide enhanced relationship graph signals is described. The productivity server includes a communication device, a memory configured to store instructions associated with a productivity service, processor(s) coupled to the memory and the communication device. The processor(s) execute the productivity service in conjunction with the instructions stored in the memory. The productivity service includes an inference engine. The inference engine is configured to retrieve one or more relationship attributes between two users of the productivity service, retrieve one or more interactivity attributes between the two users of the productivity service, generate an enhanced signal based on the relationship and interactivity attributes, and store the enhanced signal within a relationship graph.

In other examples, the inference engine is further configured to receive communication directed to a user of the productivity service, query the relationship graph for the enhanced signal associated with the user and/or the communication, and provide a value of the enhanced signal to a communication module to rank the communication among a plurality of communications. The inference engine is configured to retrieve the one or more relationship attributes and the one or more interactivity attributes by querying the relationship graph for a plurality of signals associated with the user and/or the communication and analyzing the plurality of signals to retrieve the one more relationship attributes and the one or more interactivity attributes.

In further examples, the plurality of signals include signals that indicate one or more of people who communicate with the user often, people the user is close to, a context of the communication trending around the user's colleagues, an importance of the communication, a relevance of the user based on an organizational distance to a sender of the communication, people who are in the communication and are relevant to the user, an explicit reference to the user in a body of the communication, the email is directed only to the user, how influential the sender of the communication is, a relevance of a topic of the communication to the user, and a proximity or a relationship between the user and the sender through a management chain. The explicit reference to the user in the body of the communication include one or more of a tag reference to the user and a name of the user being included in the body of the communication. The inference engine is further configured to update the enhanced signal based on the communication and store the updated enhanced

In some examples a system to provide enhanced relationship graph signals is described. The system includes one or more cloud servers executing a cloud service and a productivity server executing a productivity service. The cloud service is configured to maintain the relationship graph. The productivity service is configured to detect the communication sent to a user, query the relationship graph for a plurality of signals, retrieve one or more relationship attributes and one or more interactivity attributes between the user and a sender of the communication based on analyzing the plurality of signals, generate an enhanced signal based on the relationship and interactivity attributes, and rank the communication based on the enhanced signal.

In other examples, the productivity service is further configured to query the relationship graph for at least one other enhanced signal and further rank the communication based on the at least one other enhanced signal. The productivity service is further configured to provide the enhanced signal to the cloud service to be stored in the relationship graph.

In some examples, a means for providing enhanced relationship graph signals is described. The means for providing enhanced relationship graph signals includes a means for retrieving one or more relationship attributes between two users of a productivity service, a means for retrieving one or more interactivity attributes between the two users of the productivity service, a means for generating an enhanced signal based on the relationship and interactivity attributes, and a means for storing the enhanced signal within a relationship graph.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide enhanced relationship graph signals, the method comprising:
retrieving one or more relationship attributes between two users of a productivity service;
retrieving one or more interactivity attributes between the two users of the productivity service;
generating an enhanced signal based on the relationship and interactivity attributes; and
storing the enhanced signal within a relationship graph.

2. The method of claim 1, wherein retrieving the one or more relationship attributes and the one or more interactivity attributes comprises analyzing in each communication one or more of:
an address of a recipient,
an address of a sender,
an address of a co-recipient,
a date and time of a transmission,
a subject, and
a topic extracted from a content of the communication.

3. The method of claim 1, wherein retrieving the one or more relationship attributes further comprises:
receiving one or more of an organizational relationship signal and a social distance signal from the relationship graph; and
analyzing the organizational relationship signal and the social distance signal to retrieve the one or more relationship attributes.

4. The method of claim 3, wherein the organizational relationship signal describes a relationship between the two users that includes an associate relationship, a supervisory relationship, and a subordinate relationship.

5. The method of claim 3, wherein retrieving the one or more relationship attributes further comprises:
receiving one or more of an organizational distance signal and a managerial relationship signal from the relationship graph, wherein the organizational distance signal describes a number of people between the two users within an organization; and
analyzing the organizational distance signal and the managerial relationship signal to retrieve the one or more relationship attributes.

6. The method of claim 1, wherein retrieving the one or more relationship attributes and the one or more interactivity attributes further comprises:
querying the relationship graph for one or more signal values associated with one or more stored signals, wherein the one or more signal values are normalized to values within a value range.

7. The method of claim 6, wherein a low value within the value range for a distance signal correlates to fewer people between the two users and a high value within the value range for the distance signal correlates to more people between the two users.

8. The method of claim 6, wherein a low value within the value range for an interactivity signal correlates to fewer interactions between the two users and a high value within the value range for the interactivity signal correlates to more frequent interactions between the two users.

9. The method of claim 6, further comprising:
applying a weight value to each signal value.

10. The method of claim 9, wherein the weight value is adjustable by one or more of: one of the two users, a stakeholder, and a machine learning scheme that is configured to process the signals.

11. The method of claim 1, wherein retrieving the one or more interactivity attributes further comprises:
querying the relationship graph for a modification signal, wherein the modification signal describes a collaboration between the two users;
querying the relationship graph for a present relationship signal, wherein the present relationship signal describes an ongoing relationship between the two users;
querying the relationship graph for an interaction frequency signal, wherein the interaction frequency signal describes a frequency of the one of more interactions between the two users; and
analyzing the one or more of the modification signal, the present relationship signal, and the interaction frequency signal to retrieve the one or more interactivity attributes.

12. A productivity server to provide enhanced relationship graph signals, the productivity server comprising:
a communication device;
a memory configured to store instructions associated with a productivity service;
one or more processors coupled to the memory and the communication device, the one or more processors executing the productivity service in conjunction with the instructions stored in the memory, wherein the productivity service includes:
an inference engine configured to:
retrieve one or more relationship attributes between two users of the productivity service;
retrieve one or more interactivity attributes between the two users of the productivity service;
generate an enhanced signal based on the relationship and interactivity attributes; and
store the enhanced signal within a relationship graph.

13. The productivity server of claim 12, wherein the inference engine is further configured to:
receive a communication directed to a user of the productivity service;
query the relationship graph for the enhanced signal associated with the user and/or the communication; and
provide a value of the enhanced signal to a communication module to rank the communication among a plurality of communications.

14. The productivity server of claim 13, wherein the inference engine is configured to retrieve the one or more relationship attributes and the one or more interactivity attributes by:
querying the relationship graph for a plurality of signals associated with the user and/or the communication: and
analyzing the plurality of signals to retrieve the one or more relationship attributes and the one or more interactivity attributes.

15. The productivity server of claim 14, wherein the plurality of signals include signals that indicate one or more of people who communicate with the user often, people the user is close to, a context of the communication trending around the user's colleagues, an importance of the communication, a relevance of the user based on an organizational distance to a sender of the communication, people who are in the communication and are relevant to the user, an explicit reference to the user in a body of the communication, the email is directed only to the user, how influential the sender of the communication is, a relevance of a topic of the communication to the user, and a proximity or a relationship between the user and the sender through a management chain.

16. The productivity server of claim 15, wherein the explicit reference to the user in the body of the communication include one or more of a tag reference to the user and a name of the user being included in the body of the communication.

17. The productivity server of claim 13, wherein the inference engine is further configured to:
update the enhanced signal based on the communication; and
store the updated enhanced signal.

18. A system to provide enhanced relationship graph signals, the system comprising:
one or more cloud servers executing a cloud service, the cloud service configured to:
maintain the relationship graph;
a productivity server executing a productivity service, the productivity service configured to:
detect the communication sent to a user;
query the relationship graph for a plurality of signals;
retrieve one or more relationship attributes and one or more interactivity attributes between the user and a sender of the communication based on analyzing the plurality of signals;
generate an enhanced signal based on the relationship and interactivity attributes; and
rank the communication based on the enhanced signal.

19. The system of claim 18, wherein the productivity service is further configured to:
query the relationship graph for at least one other enhanced signal; and
further rank the communication based on the at least one other enhanced signal.

20. The system of claim 18, wherein the productivity service is further configured to:
provide the enhanced signal to the cloud service to be stored in the relationship graph.
